(19) United States
(12) Patent Application Publication
(10) Pub. No.: US 2005/0074736 A1
(43) Pub. Date: Apr. 7, 2005

(54) Multicultural educational kit

(76) Inventors: Cheryl E. Perkins, Asheboro, NC (US); Barbara J. Evans, Memphis, TN (US)

Correspondence Address: LITMAN LAW OFFICES, LTD., P.O. BOX 15035 CRYSTAL CITY STATION, ARLINGTON, VA, 22215, US

(21) Appl. No.: 10/676,120

(22) Filed: Oct. 2, 2003

(51) Int. Cl. G09B 25/00

(52) U.S. Cl. 434/365

(57) ABSTRACT

The multicultural educational kit includes a series of components relating to one or more specific cultural, ethnic, racial, national, or other population groups, for teaching young children about such different groups throughout the world and eliminating the development of early prejudices toward peoples different from one's own. The present kit preferably contains a costumed doll representing a child native to the group being studied, a video presentation describing a typical day in the life of a child of the culture, a series of finger puppets representing a family of the group being studied, a series of small picture books and corresponding audio presentations discussing various subject areas of the culture or group being studied, an activity book relating to the culture or group being studied, a regional map, and a series of flash cards having various terms or words for colors, numbers, family members, geographical features, etc.

### BACKGROUND OF THE INVENTION

1. Field of the Invention

The present invention relates generally to educational games, toys, and other devices, and more particularly to an educational kit primarily intended for use in the classroom to teach young children about different cultures of the world. The present kit contains a doll costumed to represent a given culture, ethnic background, etc., a series of picture books and audio cassettes or the like describing various aspects of the culture, an activity book and map, a glove with detachable finger puppets representing people of the culture, a video tape, and a series of flash cards containing words, numbers, and other characteristics of the language of the culture. The kit may include a series of groups of such articles, with each group comprising the above noted articles relating to a specific culture or ethnic group and with each of the groups relating to a different culture or ethnic group.

2. Description of the Related Art

There are literally hundreds of different nationalities, ethnic groups, languages, and cultures throughout the world, with each being different in at least some manner or manners from all others. Many people are inclined to feel that persons of a different race, culture, ethnic background, etc. are in some way inferior to their own. This unfortunate attitude is to a great extent due to a lack of familiarity with other cultures, and such an attitude can be difficult to overcome when a person carries it past early to mid-childhood.

As a result, many educators and others have long recognized the importance of teaching people, particularly younger children, about the differences in cultural and ethnic backgrounds of different groups throughout the world. Early education about such ethnic and cultural differences is of great value in overcoming later prejudices toward such groups.

While many different teaching aids and tools have been developed in the past to teach students about different cultures, races, ethnic groups, customs, etc., most are relatively conventional and generally use books and other printed matter, with perhaps some audiovisual material as well. It is well established that learning occurs most effectively when the maximum number of senses are employed by the student. Thus, along with the senses of sight and sound, it is preferable that students also be able to touch and handle various artifacts, toys, etc. relating to a given subject area when learning about that subject. It is also widely recognized that different ways of explaining or teaching a given point or lesson, even when relying upon the input of only one or two senses, can enable the student to better absorb the material of the lesson.

The present invention responds to the above noted need for a tool or system for teaching students about different cultures, races, customs, and ethnic backgrounds, by providing a multicultural educational kit. The present kit includes a series of different components which provide instruction about a given culture, with the kit preferably containing materials relating to at least a few different cultures or ethnic groups. The present multicultural educational kit includes at least one appropriately costumed doll relating to each culture or ethnic group provided for in the kit; at least one book or booklet relating to the given culture(s) in the kit; a corresponding number of audio tapes or CDs; one or more video presentations; a map showing each cultural area; one or more activity books for the students; a series of finger puppets representing a family of the given culture(s); and a series of flash cards relating to the culture(s). These materials may be utilized by the instructor to provide a learning experience which utilizes most of the senses of the students, and which presents the material in a number of different ways to impart a maximal learning experience.

A discussion of the related art of which the present inventors are aware, and its differences and distinctions from the present invention, is provided below.

U.S. Pat. No. 4,029,320 issued on Jun. 14, 1977 to Jack Hausman, titled “Educational Game Apparatus And Teaching System,” describes a board game configured for teaching an academic subject area (e.g., basic mathematics) . The Hausman game is generally conventional, employing a game board and a series of cards each having some form of instruction thereon, and a number of player position markers. The Hausman game is a competitive activity, unlike the teaching kit of the present invention. Moreover, Hausman does not disclose nor make use of any form of audile information or educational material, nor does he disclose any modification of his game for use in teaching students about different cultures, nationalities, or ethnic groups, as provided by the present educational kit.

U.S. Pat. No. 4,555,236 issued on Nov. 26, 1985 to Jeffrey L. Peyton, titled “Hand Actuated Puppet And Kit,” describes a simplified hand puppet device formed of two opposed flat sheets of material with a W-shaped hinge attachment therebetween. Peyton states that his puppet may be folded flat to lie in a pocket within a book or the like. However, he does not provide any additional audile teaching means, nor any tactile means for the students; the single puppet is handled only by the person doing the instructing. Moreover, Peyton does not disclose the use of his hand puppet as having a human configuration for use in teaching children about cross cultural differences, as provided by the present invention.

U.S. Pat. No. 4,595,367 issued on Jun. 17, 1986 to Maria K. Forsyth, titled “Instructional Globe,” describes a three dimensional globe having a series of removably installed components (e.g. land masses and ocean areas) thereon. The Forsyth globe is directed to the teaching of geography, and no disclosure is made of any provision for teaching cultural or ethnic differences. Moreover, Forsyth does not provide any additional teaching aids in the form of audile devices, puppets, dolls, flash cards, etc., as provided by the present invention.

U.S. Pat. No. 4,784,394 issued on Nov. 15, 1988 to Vitaly Sumin, titled “Tourist Game Apparatus,” describes a board game based upon a map of a given geographical area. Players make hypothetical trips in the area covered by the map, as tourists would when actually visiting the area. The Sumin game is a competitive activity, unlike the present educational kit invention. Moreover, Sumin does not disclose any additional apparatus for use with his game, other than cards containing information about the area of the hypothetical visit and other cards awarded to the winner(s) of the game.

U.S. Pat. No. 5,713,743 issued on Feb. 3, 1998 to Jehan Clements, titled “Storytelling Flip Over Picture Book And Method Of Providing And Presenting A Story,” describes a booklet in which the pages or leaves have text material on one side and a picture on the opposite side. The booklet is set up as an easel, with the reader reading the text from one side and the listener and viewer viewing the picture from the opposite side. Clements does not disclose the use of his picture book for cultural education or the like, nor does he disclose any puppets, dolls, audile teaching aids, or other teaching devices with his book.

U.S. Pat. No. 5,927,719 issued on Jul. 27, 1999 to Olivia L. Young, titled “Region-Suited Geography Playing Card Deck With Main Information And Place-Filler Suit Cards; A Companion Deck; And Games,” describes several embodiments of a competitive card game configured around the subject of geography. The only physical structure used by Young in her game is the cards. No puppets, audile or visual aids, or ethnic dolls are disclosed by Young for her card game. It is also noted that Young's card game is a competitive activity, rather than being a non-competitive learning experience, as provided by the present multicultural educational kit invention.

U.S. Pat. No. 6,106,302 issued on Aug. 22, 2000 to Mark J. Schumacher, titled “Educational System And Method,” describes a series of cases or containers each having a number of tactile samples therein. The samples are all related to the natural world and/or wildlife, e.g. a small sample of a pelt, feathers, wood, rock, etc. Schumacher does not provide any additional teaching aids, such as the audile device, puppets, dolls, and maps provided with the present multicultural educational kit, nor does he provide any means of teaching students about different cultures, ethnic backgrounds, and the like.

U.S. Pat. No. 6,220,864 issued on Apr. 24, 2001 to Valerie Walawender, titled “Three-Dimensional Educational Role-Playing Game Apparatus And Method Of Use,” describes a series of embodiments of a non-competitive role playing activity including a mirror, representations of people from a given culture or ethnic group, and a mask. A series of cards is also provided, with the cards containing various suggestions or questions to assist in a discussion during the role playing. A player dons a mask and observes himself or herself in the mirror, which is surrounded by representations of people of the same culture or ethnic group as that of the mask being used. The Walawender apparatus is intended more as a psychological tool for teaching students to respect the cultures and values of other people, rather than as an apparatus for teaching people about those differences per se. In any event, Walawender does not provide any form of hand puppets or dolls representing a given ethnic or cultural group, nor are any flash cards provided which have questions relating to some aspect of the language or culture of the group, as provided by the present invention.

Finally, British Patent Publication No. 2,209,862 published on May 24, 1989 to Montessori Teachers' Centre Limited, titled “An Educational Kit,” describes various embodiments of a kit containing audio and video tapes or the like, finger puppets, and a series of cards. The various materials may be directed to teaching students about a variety of different subject areas. Perhaps the closest subject area described is “grace and courtesy.” The attributes of grace and courtesy are generally considered to be fundamental in any given culture, but may vary widely between different cultures. Hence, it appears that the '862 British Patent Publication teaches away from the present invention, in that it seeks to teach children about aspects and attributes of their own native culture, rather than teaching them anything of other cultures, as is the case with the present multicultural educational kit invention. Moreover, the British '862 Patent Publication makes no disclosure of any form of doll representing a different ethnic or cultural group from that of the students utilizing the apparatus, whereas the materials of the present kit are all directed to teaching children about cultures and the like which are different from their own.

None of the above inventions and patents, taken either singly or in combination, is seen to describe the instant invention as claimed. Thus a multicultural educational kit solving the aforementioned problems is desired.

### SUMMARY OF THE INVENTION

The present multicultural educational kit comprises a series of embodiments of a kit or assembly which may be used by teachers or instructors for teaching and training younger children to appreciate and respect the differences between other cultures or ethnic groups and their own. The present kit contains subject matter and materials for teaching students about at least one, and preferably more than one, cultural, ethnic, national, etc. group which is different from the native background of the students.

A central feature of the present kit is the ethnic doll which is provided for each culture which may be contained in the kit. The doll preferably represents a child of the culture to be studied, and is provided with a name, features, and costume corresponding to the subject matter and materials of the ethnic or cultural group being studied. The kit may also contain a video tape or disc which describes a typical day in the life of a child of the culture, with the doll representing that child. A series of finger puppets may also be provided, to represent a family of the culture or ethnic group being studied. The kit also contains a series of small picture books and corresponding audio presentations (tapes, CDs, etc.) which discuss various subject areas of the culture or group being studied, such as the people and customs, geography and climate, animals, food, transportation, and/or architecture and communities. An activity book relating to the culture or group being studied is also provided, with the material of the activity book being adaptable to copying and distribution to all students of the class. A plasticized map of the region is also provided, which may be marked and erased using a dry-erase type marker or the like. Finally, a series of flash cards having various terms or words for colors, numbers, members of the family, geographical features, etc., may be provided with the kit.

While a kit according to the present invention may contain the above noted elements and components relating to only a single cultural or ethnic group, nationality, etc., it will be seen that such a kit may contain such materials for two, or even more, different groups, nations, etc. Such multiple cultural kits may contain materials relating to relatively closely related cultures (e.g., Spanish and Portuguese, Scandinavian or Nordic countries and peoples, etc.), or may contain materials about less closely related peoples or cultures, as desired.

Accordingly, it is an object of the invention to provide a multicultural educational kit containing educational materials relating to at least one ethnic, cultural, national, or similar group of people, for teaching young children cultures and peoples different from their own.

It is another object of the invention to provide a multicultural educational kit containing a costumed doll representing a child of the subject culture, along with a series of finger puppets representing a native family of the culture, a series of books and audio materials, a video presentation, an activity book, a map, and a series of flash cards all relating to the subject culture.

It is a further object of the invention to provide and distribute materials from the activity book to all students of the class to enable all students to work on a given exercise or project from the activity book, simultaneously.

Still another object of the invention is to provide a multicultural educational kit, at least one embodiment of which contains materials relating to two or more different cultural, ethnic, or national groups, in which the different groups may be closely related or relatively unrelated as desired.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top plan view of a multicultural educational kit according to the present invention, showing the various elements relating to a specific culture or ethnic group as packaged in a box or similar container.

FIG. 2A is a front elevation view of a costumed doll representing a child belonging to the ethnic group or culture represented by the multicultural kit of FIG. 1.

FIG. 2B is a perspective view of a series of picture books and corresponding video and audio tapes relating to the culture described in the kit of FIG. 1.

FIG. 2C is a plan view of a map representing the area of the culture of the kit of FIG. 1.

FIG. 2D is an environmental front elevation view of a series of finger puppets representing a native family of the culture described in the kit of FIG. 1.

FIG. 2E is a front elevation view of a series of flash cards relating to the culture of the kit of FIG. 1.

FIG. 3A is a front elevation view of a costumed doll representing a child belonging to a second ethnic group or culture which may be represented by the present multicultural kit.

FIG. 3B is a perspective view of a series of picture books and corresponding video and audio tapes relating to the second culture represented by the doll of FIG. 3A.

FIG. 3C is a plan view of a map representing the area of the culture of the doll of FIG. 3A.

FIG. 3D is an environmental front elevation view of a series of finger puppets representing a native family of the culture of the doll of FIG. 3A.

FIG. 3E is a front elevation view of a series of flash cards relating to the culture of the doll of FIG. 3A.

Similar reference characters denote corresponding features consistently throughout the attached drawings.

### DETAILED DESCRIPTION OF THE PREFERRED EMBODIMENTS

The present invention comprises various embodiments of a multicultural educational kit for teaching children about cultures, ethnic groups, and peoples different from their own. The present kit includes a series of different components and audiovisual aids which serve to stimulate learning among children by means of multiple sensory inputs. Each kit may contain materials directed to only a single ethnic or cultural group, i.e. a second culture as opposed to the first or native culture of the child, or may contain materials related to two or more different cultural groups.

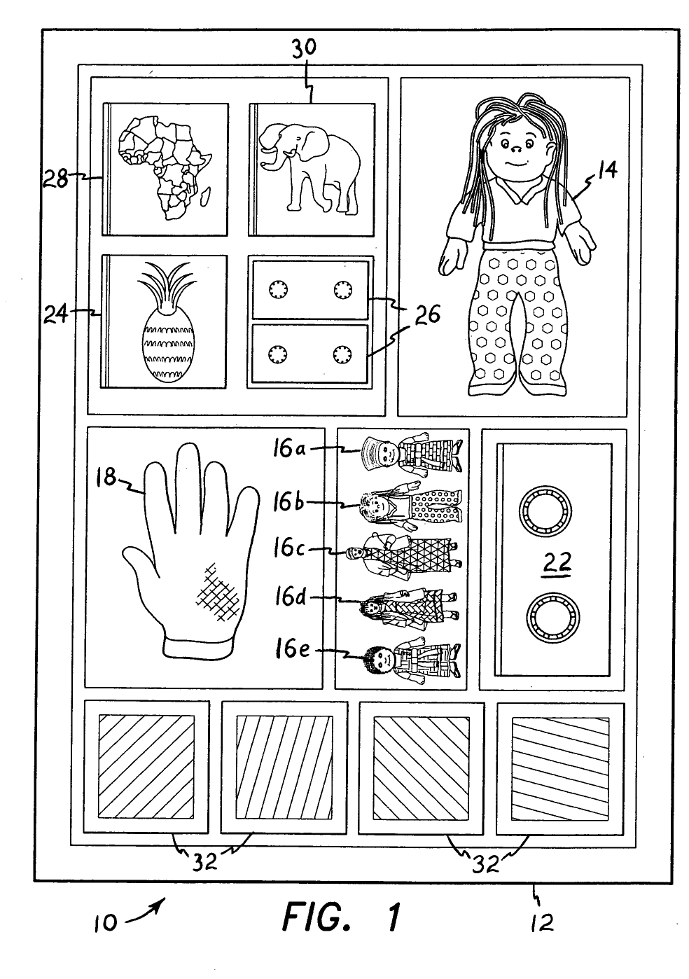

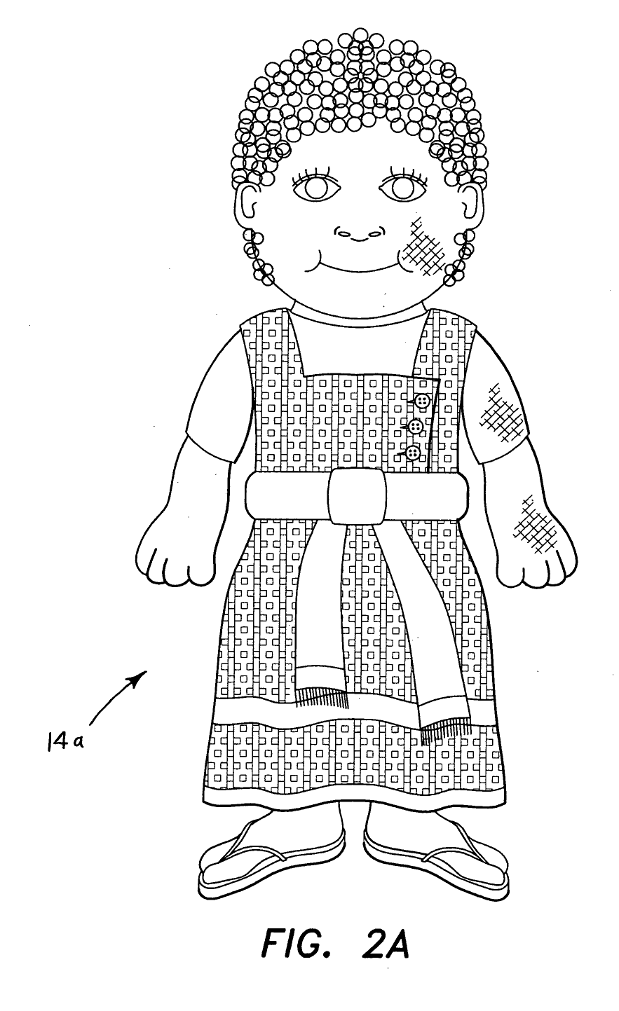

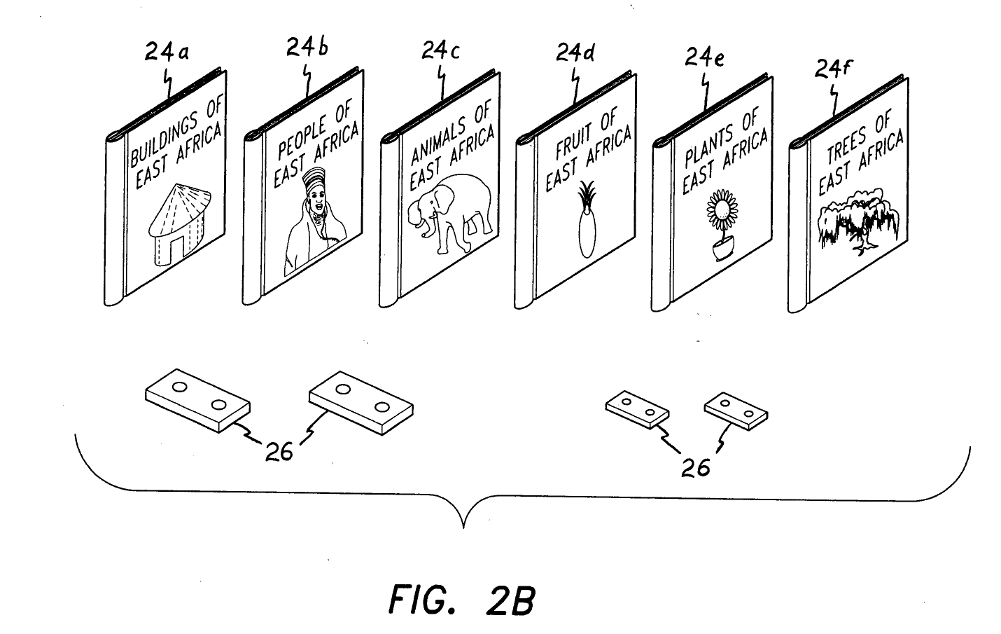

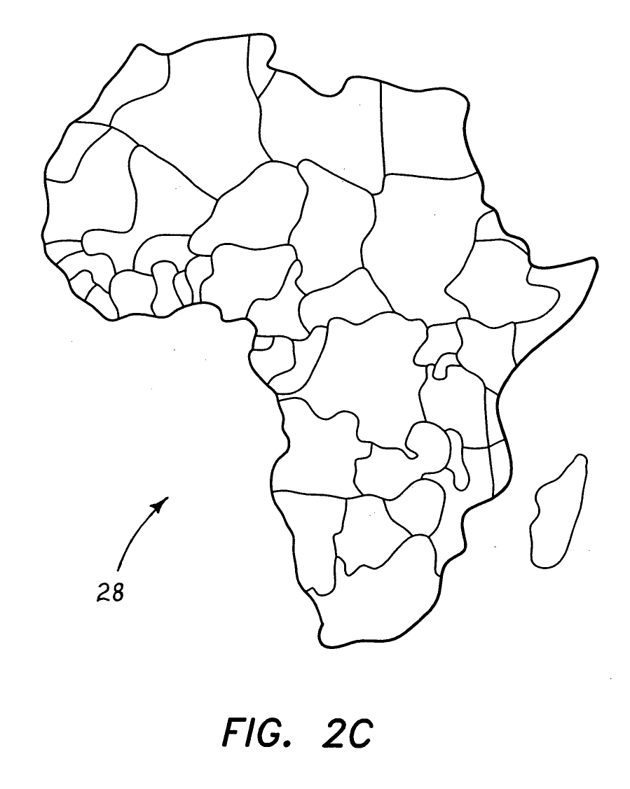

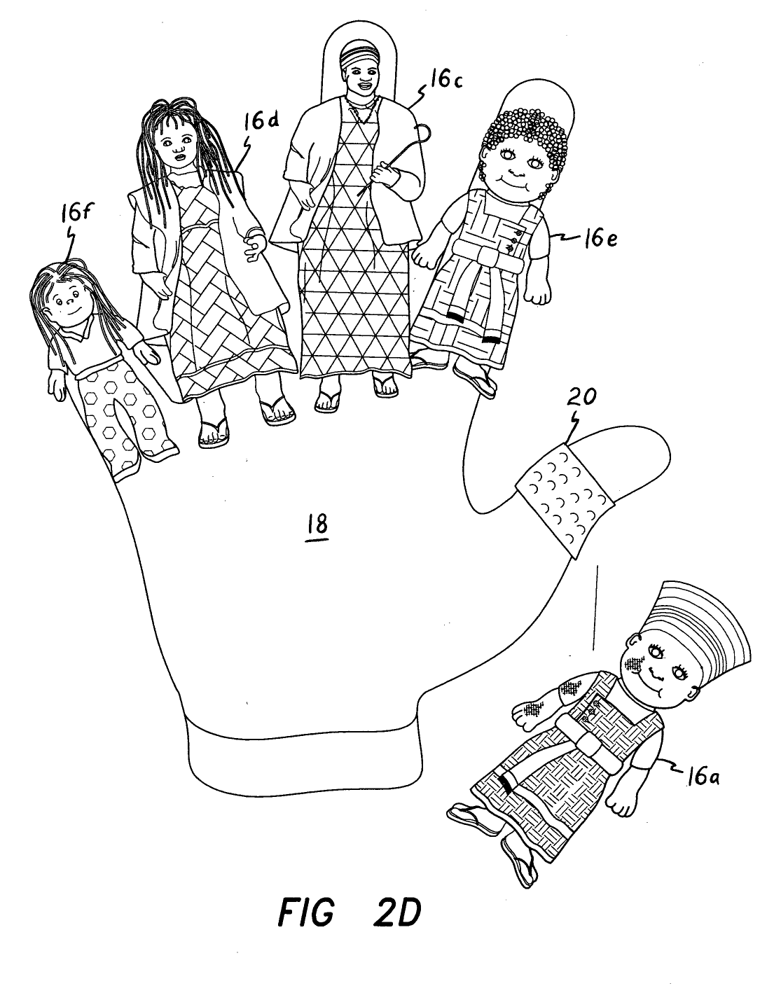

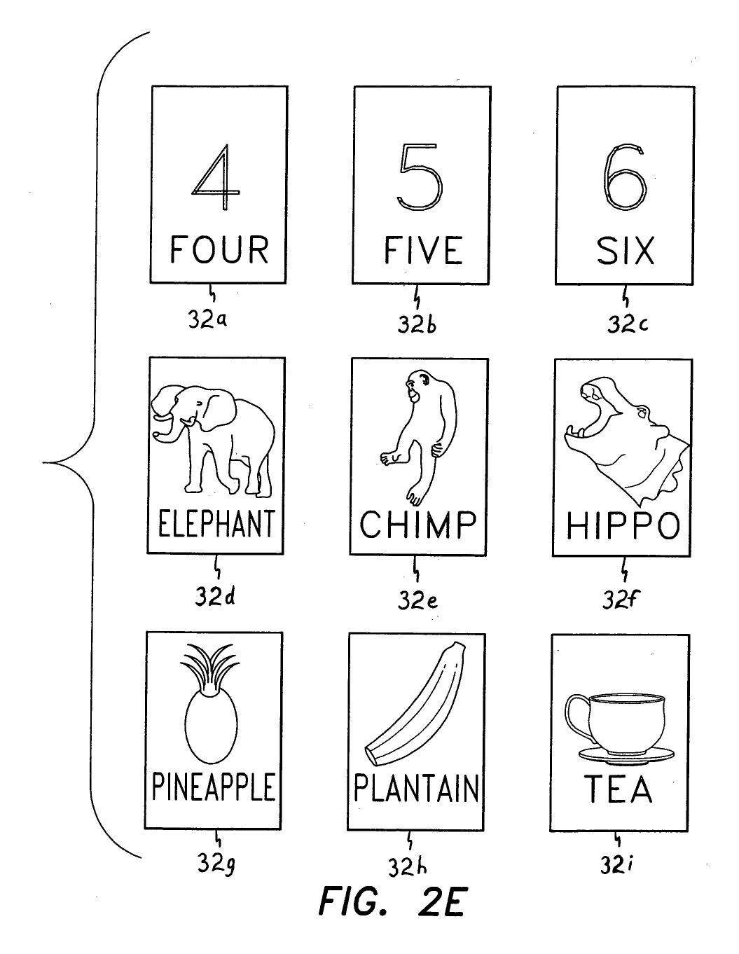

FIG. 1 illustrates a first embodiment of a multicultural educational kit 10 according to the present invention. The kit 10 may be provided in a box or container 12 (or alternatively, a rigid case or flexible bag or sack, etc.) in order to keep all components together when not in use. The kit 10 includes a number of different components and articles, with the overall package directed to providing multicultural education utilizing a variety of different teaching means and sensory inputs for the students. For example, the kit 10 preferably includes a soft sculpture costumed doll 14 which is configured and dressed to represent a child of the culture represented in the kit 10 and being studied. The doll 14 is preferably in the form of a child, in order that children may identify more closely with the doll and its culture. FIG. 2A provides a detailed view of such a costumed doll 14a, dressed and configured in the same manner as the child finger puppet 16e, discussed below. The costumed doll(s) 14 and/or 14a may be dressed and configured to match one of the finger puppets, or may be dressed and configured uniquely, as desired.

The kit 10 may also include a series of finger puppets 16a through 16e (or 16f), configured to represent a family of the culture or ethnic group represented in the kit 10. A finger puppet glove 18 with removable finger puppet attachment means (e.g., a loop of hook and loop fastening material, such as Velcro® 20, adapted for attachment to the fingers and thumb, as shown in FIG. 2D, or other means as desired) is also provided. The larger costumed doll 14 and finger puppet family 16a through 16e (or 16f) represent the same culture, e.g. an area of east central Africa, or other cultural or ethnic group as desired, so long as they relate to the same culture. FIG. 2D provides a detailed view of the finger puppets 16a through 16d and a different finger puppet 16f configured identically to the larger costumed doll 14 of FIG. 1, the finger puppet glove 18, and the Velcro® 20 on the thumb of the glove 18, providing for the removable attachment of the various puppets 16a through 16e or 16f to the glove 18.

The kit 10 also preferably contains a video presentation (e.g. videotape 22, or alternatively a DVD or other video format as desired) which provides an audiovisual presentation of a period in the life of a child of the culture being studied. The costumed doll 14 may be used to represent the child, and provide tactile sensory input in addition to the audiovisual input provided by the video presentation 22. Preferably, the video presentation is relatively short, e.g. on the order of one-half hour or so, in order to avoid overtaxing the attention spans of the relatively young children at which the present educational kit 10 is aimed. However, the presentation may be formed of a series of chapters or episodes which may be viewed or experienced over several sessions, if so desired.

The present multicultural educational kit 10 may also include a series of picture books 24, with FIG. 2B illustrating a series of six such books 24a through 24f. The books 24a through 24f each preferably cover a different subject area of the culture or ethnic group being studied. For example, book 24a may cover architecture and native homes and structures; book 24b may be on the subject of the people of the area; book 24c may cover animals indigenous to the area, and/or domesticated animals; and books 24d through 24f may be on the subject of different types of native and/or agricultural plants of the area. Other subjects may be provided in lieu of or in addition to the subjects noted above, e.g., transportation, geography and climate, etc. Each of the books 24a through 24f preferably includes an audio presentation therewith, e.g. the audio tapes 26 shown in FIG. 2B. While only four tapes 26 are shown in FIG. 2B, preferably each book 24a through 24f includes its own tape 26 or other audio presentation specific to the subject area of the book. The pictures of the books 24a through 24f are displayed and coordinated with the corresponding audio presentations, to provide both visual and audio sensory input for the students.

The kit 10 also contains a map 28 of the continent, region, or other area in which the subject culture or ethnic group resides. The map 28 is preferably folded, rolled, or otherwise compacted for storage within the kit container 12, as shown in FIG. 1, with the enlarged map 28 of FIG. 2c representing the opened map to facilitate viewing. Preferably, the map 28 is provided with a glossy, waterproof surface in order to allow the use of erasable markers thereon. Such erasable markers and surface areas upon which they may be used are conventional, and such markers (not shown) may be provided with the present multicultural educational kit 10, if so desired.

The present kit 10 preferably also includes an activity book 30, as shown in one of the compartments of the container 12 of FIG. 1. The activity book 30 contains a series of reproducible exercise and activity sheets for students, such as puzzles, pages which may be colored, various craft projects (e.g., cut out and assemble), simple recipes from the culture or ethnic group being studied, and games and rules or instructions. Such components are conventional, and need not be illustrated or discussed in detail here. The various games, puzzles, coloring pages, etc. of the activity book 30 may be removed by the instructor or adult supervisor and copied, in order that all of the children receiving the lesson may have their own page from the activity book 30 to perform the assigned activity. In some cases, e.g. recipes, the instructor or adult supervisor may perform the activity himself or herself, with the children enjoying the results during or after completion of the activity.

The present multicultural educational kit 10 may also contain a series of flash cards 32 relating to the culture or ethnic group being studied. FIG. 2E illustrates a series of such cards, designated as cards 32a through 32i. The cards 32 may be in sets, with each set relating to a specific subject area. In the exemplary cards of FIG. 2E, the cards 32a through 32c display Arabic numerals and the corresponding English word for each numeral displayed. It will be seen that the words and/or numerical symbols may be in a language native to the culture or area being studied, if so desired. Cards 32d through 32f relate to various animals native to the area (e.g., east Africa), with corresponding names. Finally, flash cards 32g through 32i relate to various agricultural plants of the area. The cards may or may not have the English or native words for the articles shown thereon, as desired, in order to cause the students to come up with the appropriate name for the article or object shown. Other subject areas, e.g. words for family members, natural objects, household objects, words used in school or education, transportation used in the subject culture, native foods, native clothing, etc., may be provided on such flash cards as desired.

To this point, only a single culture or ethnic group which is not native to the students or children making use of the present kit has been shown and described. However, it will be noted that the present multicultural educational kit is not limited to only a single specific culture, e.g., east Africa. The present kit 10 may contain components and articles for teaching about innumerable different cultures, as desired.

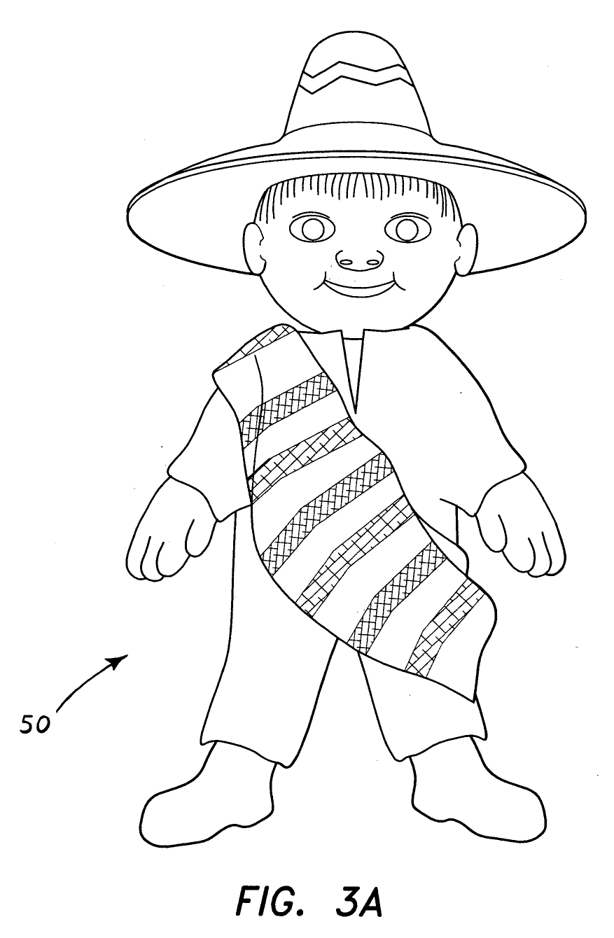

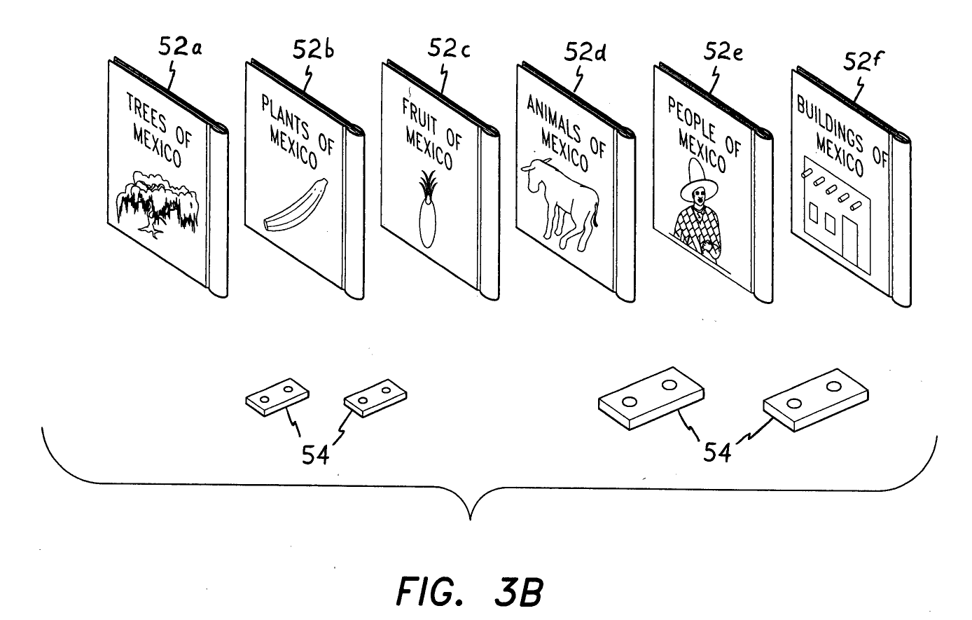

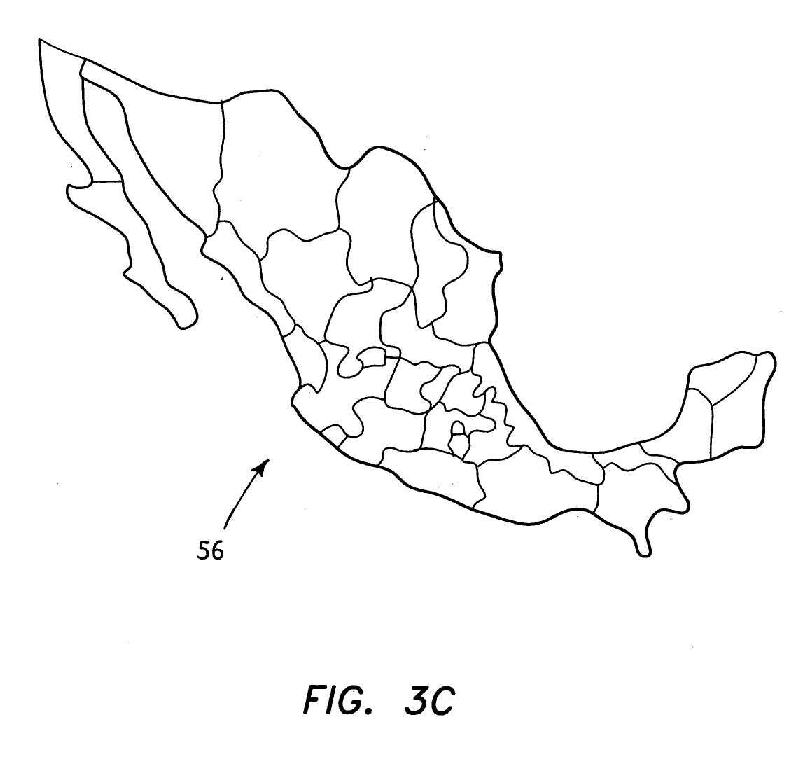

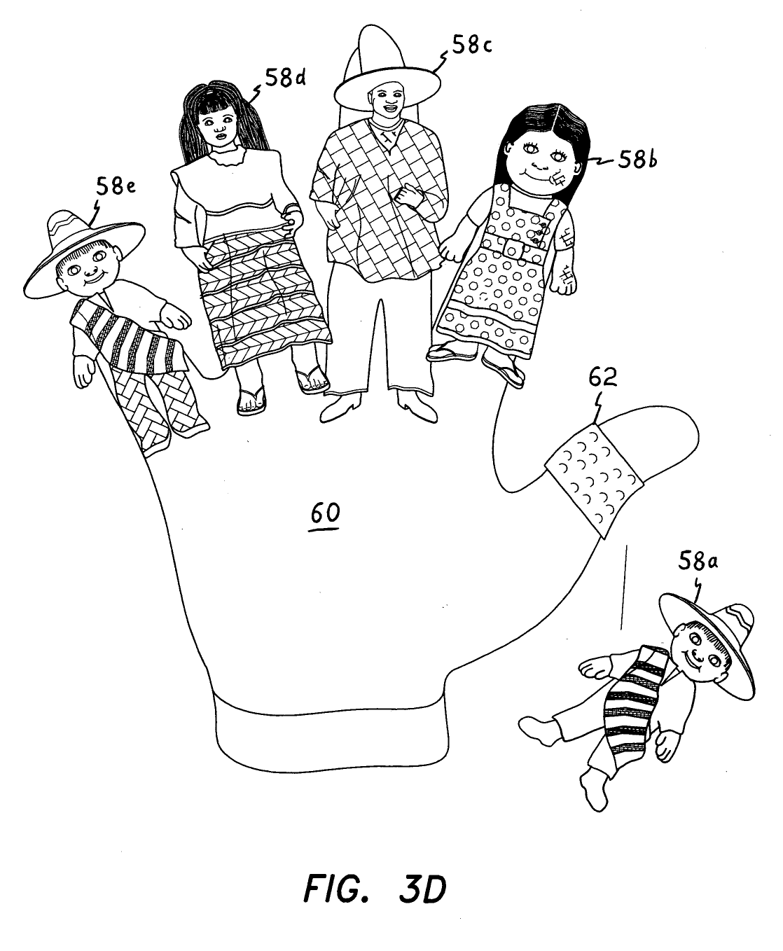

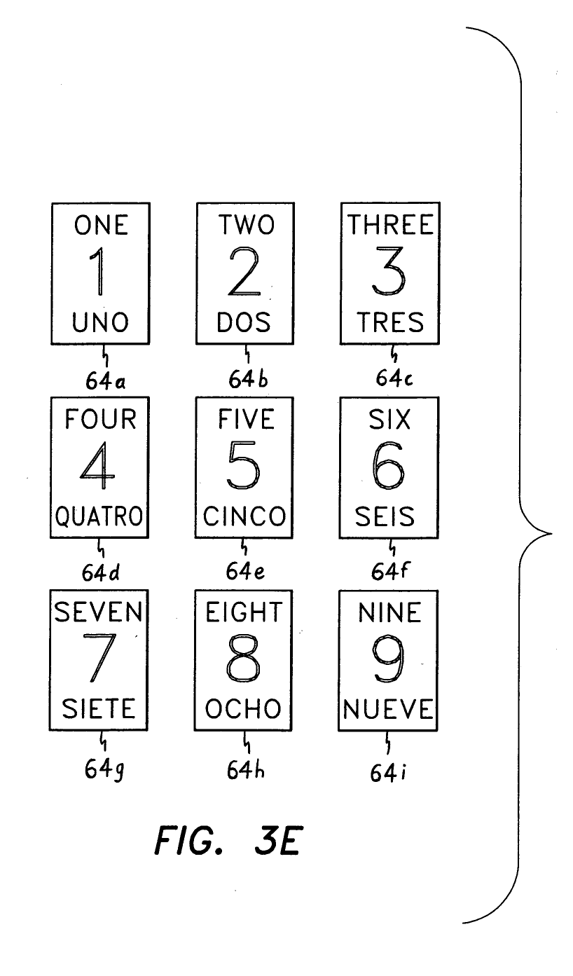

FIGS. 3A through 3E provide examples of such components which relate to the culture and ethnic people of Mexico. It will be seen that the components illustrated in FIGS. 3A through 3E may be provided in a separate kit, if so desired, or the kit 10 may include materials for teaching about two or more different cultures or ethnic groups (e.g. east Africa and Mexico), if so desired.

FIG. 3A illustrates a costumed doll 50, representing a boy wearing ethnic apparel for the nation of Mexico. The doll 50 is essentially analogous to the costumed dolls 14 and 14a of the east African cultural kit, illustrated in FIGS. 1 and 2A.

FIG. 3B illustrates a series of picture books 52a through 52f along with corresponding audio presentations, e.g. tapes 54. The subject areas of the various books 52a through 52f and their corresponding tapes 54 relate to various aspects of Mexican culture and life and/or the people and customs of Mexico, and are analogous to the picture books 24a through 24f and corresponding audio tapes 26 of FIG. 2B discussed further above, used to teach children about the culture of east Africa.

FIG. 3C provides an illustration of a map 56 of Mexico, which may be used in the same manner as that described further above for the map 28 of east Africa in teaching children of the culture of that portion of the world. While the map 28 of east Africa is divided into separate nations, the map 56 of Mexico comprises a single nation, with that map 56 being divided into its various states. The maps provided with the present multicultural educational kit 10 may encompass as much or as little area and detail as required to show the area of the people being studied. As in the case of the map 28 of Africa, the map 56 of Mexico is preferably provided with a surface compatible with the use of conventional dry erase markers or the like.

FIG. 3D provides an illustration of a series of finger puppets 58a through 58e, representing a Mexican family. The finger puppets 58a through 58e are used in essentially the same manner as the finger puppets 16a through 16e or 16f of FIGS. 1 and 2d, to add to the story provided by the picture books 52a through 52f and their corresponding audio presentations 54. A finger puppet glove 60 having Velcro® or other attachment means 62 at the thumb and each finger, is also provided for the removable attachment of the finger puppets 58a through 58e thereto.

The second embodiment kit illustrated in FIGS. 3A through 3E also contains various sets of flash cards, examples of which are illustrated in FIG. 3E. The cards 64a through 64i include the Arabic numerals one through nine, with the corresponding English and Spanish words for those numbers. It will be seen that other subjects may be provided for such flash cards as desired, e.g. the subjects described further above for the flash cards 32a through 32i of FIG. 2E relating to various aspects of east African culture.

The various alternative embodiment kits containing materials directed to different cultures preferably contain all of the various articles and materials described further above in the discussion of the kit 10 of FIGS. 1 through 2E, relating to east African culture. Thus, the kit of FIGS. 3A through 3E relating to Mexican culture also includes a video tape or other video presentation (DVD, etc.) and activity book. The video and activity book of the kit relating to Mexican culture are not illustrated, but are understood to be analogous to those equivalent articles provided in the kit 10 relating to the culture of east Africa, with the subject matter differing accordingly.

The present multicultural educational kit is used by first selecting the specific culture, ethnic group, native people, etc. to be studied. The various components of the kit, e.g. the doll, finger puppets and glove, video presentation, picture books and audio presentations, map, activity book, and/or flash cards, are retrieved from the appropriate kit for the cultural or ethnic group to be studied. The teacher or adult supervisor may display or pass around the larger costumed doll for the students to handle, while donning the finger puppet glove and applying the finger puppets thereto. The video presentation, or one of the picture books and its accompanying audio presentation, may be played or displayed while the instructor manipulates the finger puppet glove with its family of finger puppets.

The activity book is used as described further above, with the instructor or supervisor making copies of various activity sheets therein in accordance with the number of students in the class or group. The copies of the selected sheet are handed out to the students to perform the selected exercise (coloring, working a maze or other puzzle, etc.) in accordance with the activity sheet and instructions provided. Alternatively, the teacher or adult supervisor may demonstrate an activity selected from the activity book, e.g. preparation of a recipe, etc., if such a demonstration is more appropriate for the given activity.

The map displaying the nation or other area of the corresponding cultural or ethnic group is also displayed during the lesson. The instructor may mark appropriate areas of the map with various notations relating to the culture, e.g. specific nations or areas where certain languages or dialects are spoken, areas where certain agricultural products are grown, areas where certain minerals are found, etc., as desired.

The flash cards provided with the present invention are used conventionally, with the instructor displaying the cards singly for students to respond to the question or problem raised by the card, e.g. identifying an animal or other symbol, etc. In some cases, it may be preferable to provide the students with some background or education about the subject culture, before using the flash cards. An example of such would be counting in the native language of the culture, where the students must learn the numbers first. The flash cards may then be used to challenge and test the students in their new knowledge.

In conclusion, the present multicultural educational kit provides an entertaining means of teaching students, most particularly younger children, about cultures, ethnic groups, and customs different from their own. The present kit greatly assists in overcoming prejudices toward other cultures and people, which often develop early in life. The gathering of a number of different media or materials into a single kit which is directed to a specific culture greatly reduces the workload of the teacher or other person performing such cultural training. Also, the multicultural educational kit of the present invention may include materials directed to more than a single culture, if so desired. This facilitates the tasks of the teacher or supervisor even further, and enables the teacher to more easily compare and contrast different cultures and ethnic backgrounds with that of the students. The present multicultural educational kit will thus prove to be of great value in the classroom and in other areas where the teaching of different cultures is performed.

It is to be understood that the present invention is not limited to the embodiments described above, but encompasses any and all embodiments within the scope of the following claims.

1. A multicultural educational kit for teaching children of a first culture about at least a second culture different from their own first culture, the kit including a plurality of second culture components comprising:
at least one costumed doll configured to represent a child of the second culture;
a finger puppet glove;
a plurality of finger puppets removably attached to said finger puppet glove, said finger puppets being configured to represent a family of the second culture; and
at least one video presentation showing a typical period in a life of a child of the second culture.

2. The multicultural educational kit according to claim 1, further including:
a plurality of picture books, with each of said books relating to a subject area of the second culture; and
a plurality of audio presentations corresponding to said plurality of picture books.

3. The multicultural educational kit according to claim 1, further including at least one activity book relating to the second culture and containing a plurality of reproducible activity sheets.

4. The multicultural educational kit according to claim 3, wherein said plurality of reproducible activity sheets further include puzzles, coloring pages, craft projects, recipes, and games and instructions therefor.

5. The multicultural educational kit according to claim 1, further including a map relating to a region of the second culture.

6. The multicultural educational kit according to claim 5, further including an erasable surface disposed over said map.

7. The multicultural educational kit according to claim 1, further including a plurality of flash cards, each of the flash cards having at least one symbol thereon representing a corresponding aspect of the second culture.

8. The multicultural educational kit according to claim 1, further including a plurality of additional culture components of a third culture.

9. The multicultural educational kit according to claim 1, further including a storage container.

10. A method of teaching children of a first culture about a second culture different from the first culture, comprising the steps of:
(a) providing at least one costumed doll configured to represent a child of the second culture;
(b) further providing a finger puppet glove;
(c) further providing a plurality of finger puppets configured to represent a family of the second culture;
(d) further providing at least one video presentation having a story of a period in a life of a child of the second culture;
(e) displaying the costumed doll, thereby representing the second culture being taught;
(f) donning the finger puppet glove;
(g) removably applying the finger puppets to the finger puppet glove;
(h) playing the video presentation; and
(i) manipulating the finger puppets in accordance with the story of the video presentation.

11. The method of teaching according to claim 10, further including the steps of:
(a) providing a plurality of picture books, with each of the books relating to a subject area of the second culture;
(b) further providing a plurality of audio presentations corresponding to the plurality of picture books;
(c) selecting one of the picture books and a corresponding one of the audio presentations;
(d) playing the audio presentation corresponding to the selected one of the picture books; and
(e) displaying pictures in the selected picture book in accordance with information on the audio tape as it is played.

12. The method of teaching according to claim 10, further including the steps of:
(a) further providing at least one activity book relating to the second culture containing a plurality of reproducible activity sheets, each of the sheets having a different activity thereon;
(b) reproducing at least one of the activity sheets, as desired;
(c) distributing the reproduced activity sheet to the children; and
(d) assigning the children to perform the activity of the reproduced and distributed activity sheet.

13. The method of teaching according to claim 10, further including the steps of:
(a) providing a map relating to a region of the second culture; and
(b) indicating to the children various features on the map relating to the second culture.

14. The method of teaching according to claim 10, further including the steps of:
(a) providing a plurality of flash cards relating to the second culture;
(b) placing at least one symbol representing a corresponding aspect of the second culture upon each of the flash cards; and
(c) exhibiting the flash cards to the children.

15. The method of teaching according to claim 10, further including the step of providing a plurality of additional culture components of a third culture.

16. The method of teaching according to claim 10, further including the step of providing a storage container.
